(19) United States
(12) Patent Application Publication
(10) Pub. No.: US 2007/0115523 A1
(43) Pub. Date: May 24, 2007

(54) Holographic memory device

(75) Inventors: Yoshiyuki Matsumura, Anpachi-Gun (JP); Ian Russell Redmond, Boulder, CO (US)

Correspondence Address: MCDERMOTT WILL & EMERY LLP, 600 13TH STREET, N.W., WASHINGTON, DC, 20005-3096, US

(73) Assignees: SANYO ELECTRIC CO., LTD.; Inphase Technologies

(21) Appl. No.: 11/283,966

(22) Filed: Nov. 22, 2005

(51) Int. Cl. G03H 1/28

(52) U.S. Cl. 359/24; 359/35

(57) ABSTRACT

To properly reproduce information from a holographic memory even when a tilt error occurs in a direction vertical to a surface including optical axes of data light and reference light. During reproduction, a holographic memory (10) is fed stepwise from an initial access position with respect to a reproduction target block within a fixed back and forth range in a disk circumferential direction. In each stepwise-fed position, an SNR of a reproduction signal is calculated by an SNR calculation circuit (19) to detect the quality of the reproduction signal. A disk circumferential direction position in which an SNR becomes best is set in a circumferential direction position with respect to the reproduction target block.

### BACKGROUND OF THE INVENTION

1. Field of the Invention

The present invention relates to a holographic memory device for reproducing information from a holographic memory in which information is recorded by fixing an interference fringe generated by an interference caused therein between a data light and a reference light, and is particularly suitable for use in correcting a tilt error between the holographic memory and the reference light.

2. Description of the Related Art

Generally, in the holographic memory, information is recorded by fixing an interference fringe, which is generated by an interference caused therein between a data light and a reference light, on a holographic memory material layer. In this case, the data light is subjected to spatial light modulation according to the information to be recorded. Therefore, when the data light and the reference light are applied to the holographic memory, a bright and dark interference fringe is generated in the holographic memory material layer according to the information to be recorded. A highly polymeric monomer in the holographic memory material layer is drawn to a “bright” area of the interference fringe to be polymerized, thereby fixing a refractive index distribution in the holographic memory material layer corresponding to the interference fringe. As a result, information is recorded in the holographic memory.

It is known that in the holographic memory, plural kinds of information can be simultaneously recorded in one recording area (recording block) by changing an incident angle of the reference light with respect to the holographic memory material layer (angular multiplexing). That is, the data light undergoes spatial light modulation each time the incident angle of the reference light is changed for different kinds of information, whereby interference fringes each corresponding to a different piece of information to be recorded are separately fixed in the same recording area for each incident angle.

During reproduction, the reference light is applied to the holographic memory material layer at the same angle at which the reference light is applied during the recording. Thus, diffraction occurs in the reference light according to the interference fringe of the angle, and the diffracted reference light is received by a photoreceptor element to reproduce the information recorded at the angle.

JP-A-11-16374 and JP-A-2000-338846 each describe a holographic memory device based on angular multiplexing.

In a case of recording information by angular multiplexing, generally, an incident angle of a reference light with respect to a holographic material layer is changed in an in-plane direction of a surface including the optical axes of the data light and the reference light. Thus, even when a tilt error occurs between the holographic memory and the reference light in the in-plane direction during reproduction, the incident angle of the reference light with respect to the holographic memory can be adjusted to a proper state through controlling an actuator (galvano mirror or the like) for adjusting the reference light according to the tilt error.

For example, as shown in FIG. 10A, when an interference fringe is generated in the holographic memory material layer, even if a tilt occurs in a plane along the line X-Y in FIG. 10A in the holographic memory during reproduction, the reference light actuator is driven and controlled to correct the incident angle of the reference light as shown in FIG. 10B, to thereby make the reference light to be incident on the holographic memory at a proper angle.

However, if a tilt error occurs in a direction vertical to the surface including the optical axes of the data light and the reference light, i.e., if a tilt error occurs in the in-plane direction of the plane along the line X-Z of FIG. 10A, a direction vector of the interference fringe is provided with a vector component different from a driving direction of the reference light actuator. Accordingly, this vector component cannot be suppressed only by controlling the reference light actuator. In this case, even when the reference light actuator is controlled, an angle between the interference fringe and the reference light is different from that during recording, making it impossible to obtain a proper reproduction signal.

### SUMMARY OF THE INVENTION

The present invention has been made to solve the above-described problem, and it is an object of the invention to provide a holographic memory device capable of properly reproducing information from a holographic memory even when a tilt error occurs in the holographic memory in a direction vertical to a surface including optical axes of data light and reference light.

According to a first aspect of the present invention, a holographic memory device for reproducing binary data of 1 and 0, which are recorded in a holographic memory medium by being optically modulated for each pixel, by applying a reference light to the holographic memory medium is characterized by including: photodetecting means for detecting the reference light diffracted by the holographic memory medium and outputting a signal for each pixel based on a diffracted state; quality detecting means for detecting quality of the signal output from the photodetecting means; position changing means for changing a rotational position of the holographic memory medium; position detecting means for detecting the rotational position of the holographic memory medium when the quality is proper based on a detecting result by the quality detecting means; and reproduction data obtaining means for obtaining reproduction data from the signal output from the photodetecting means when the holographic memory medium is in the rotational position detected by the position detecting means.

According to a second aspect of the present invention, in the holographic memory device according to the first aspect of the present invention, quality detecting means detects the quality of the signal output from the photodetecting means each time the rotational position of the holographic memory medium is changed, and the position detecting means detects a rotational position, at which the quality detected by the quality detecting means is best, as the rotational position of the holographic memory during the reproduction.

According to a third aspect of the present invention, in the holographic memory device according to the first or the second aspect of the present invention, the quality detecting means detects the quality of the signal output from the photodetecting means based on a difference between an average value μ1 of signal values of a signal group corresponding to the binary data of 1 and an average value μ0 of signal values of a signal group corresponding to the binary data of 0 among the signals output from the photodetecting means for the respective pixels.

According to a fourth aspect of the present invention, in the holographic memory device according to the first or the second aspect of the present invention, the quality detecting means detects the quality of the signal output from the photodetecting means based on a sum of a standard deviation σ1 of signal values of a signal group corresponding to the binary data of 1 and a standard deviation σ0 of signal values of a signal group corresponding to the binary data of 0 among the signals output from the photodetecting means for the respective pixels.

According to a fifth aspect of the present invention, in the holographic memory device according to the first or the second aspect of the present invention, the quality detecting means detects the quality of the signal output from the photodetecting means based on a difference between an average value μ1 of signal values of a signal group corresponding to the binary data of 1 and an average value μ0 of signal values of a signal group corresponding to the binary data of 0, and a sum of a standard deviation σ1 of signal values of the signal group corresponding to the binary data of 1 and a standard deviation σ0 of signal values of the signal group corresponding to the binary data of 0, among the signals output from the photodetecting means for the respective pixels.

According to a sixth aspect of the present invention, a holographic memory device for reproducing data recorded in a holographic memory medium by applying a reference light to the holographic memory medium is characterized by including: tilt detecting means for detecting a tilt of the holographic memory medium; and adjusting means for adjusting, based on a detecting result by the tilt detecting means, a rotational position of the holographic memory medium to a position at which an influence of the tilt is suppressed.

According to a seventh aspect of the present invention, in the holographic memory device according to the sixth aspect of the present invention, the adjusting means is provided with a table in which an amount of the tilt and a correction amount of the rotational position are associated with each other.

According to a eighth aspect of the present invention, a holographic memory device for reproducing data recorded in a holographic memory medium by applying a reference light to the holographic memory medium is characterized by comprising: photodetecting element for detecting the reference light diffracted by the holographic memory medium and outputting a signal for each pixel based on a diffracted state; and control circuit for performing processing including: quality detecting processing for detecting quality of the signal output from the photodetecting element; position changing processing for changing a rotational position of the holographic memory medium; position detecting processing for detecting the rotational position of the holographic memory medium when the quality is proper based on a detecting result in the quality detecting processing; and reproduction data obtaining processing for obtaining reproduction data from the signal output from the photodetecting means when the holographic memory medium is in the rotational position detected in the position detecting processing.

According to a ninth aspect of the present invention, in the holographic memory device according to the eighth aspect of the present invention, the quality detecting processing detects the quality of the signal output from the photodetecting element each time the rotational position of the holographic memory medium is changed; and the position detecting processing detects a rotational position, at which the quality detected in the quality detecting processing is best, as the rotational position of the holographic memory during the reproduction.

According to the present invention, even when a tilt error occurs in a direction vertical to a surface including the optical axes of the data light and reference light, it is possible to obtain high-quality reproduction data by adjusting the rotational position of a holographic memory medium to a proper position.

### BRIEF DESCRIPTION OF THE DRAWINGS

The above-mentioned and other objects of the present invention and the novel features there of will be more completely clear when the following description of the embodiment is read with reference to the accompanying drawings, in which:

FIG. 1 is a diagram showing an optical system of a hologram memory device according to Embodiment 1 of the present invention.

FIG. 2 is a diagram showing a configuration of the hologram memory device according to Embodiment 1 of the present invention.

FIG. 3 is a diagram illustrating an SNR calculation method according to Embodiment 1 of the present invention.

FIG. 4 is a flowchart showing a reproducing operation of the hologram memory device according to Embodiment 1 of the present invention.

FIGS. 5A and 5B are diagrams illustrating tilt correction operations according to Embodiment 1 of the present invention.

FIGS. 6A and 6B are diagrams illustrating tilt correction operations according to Embodiment 1 of the present invention.

FIG. 7 is a diagram showing an optical system of a hologram memory device according to Embodiment 2 of the present invention.

FIG. 8 is a diagram showing a configuration of the hologram memory device according to Embodiment 2 of the present invention.

FIG. 9 is a flowchart showing a reproducing operation of the hologram memory device according to Embodiment 2 of the present invention.

FIGS. 10A and 10B are diagrams illustrating relations between interference fringes and tilt.

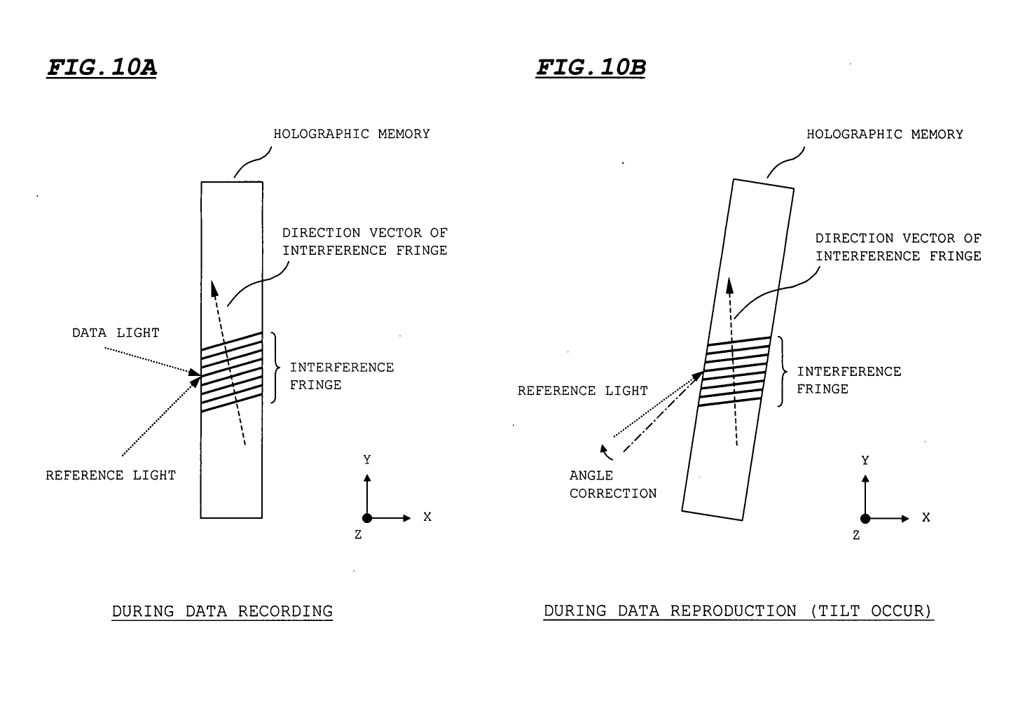

It is to be expressly understood, however, that the drawings are for purpose of illustration only and is not intended as a definition of the limits of invention.

### DETAILED DESCRIPTION OF THE PREFERRED EMBODIMENT

Hereinafter, embodiments of the present invention will be described with reference to the drawings.

### Embodiment 1

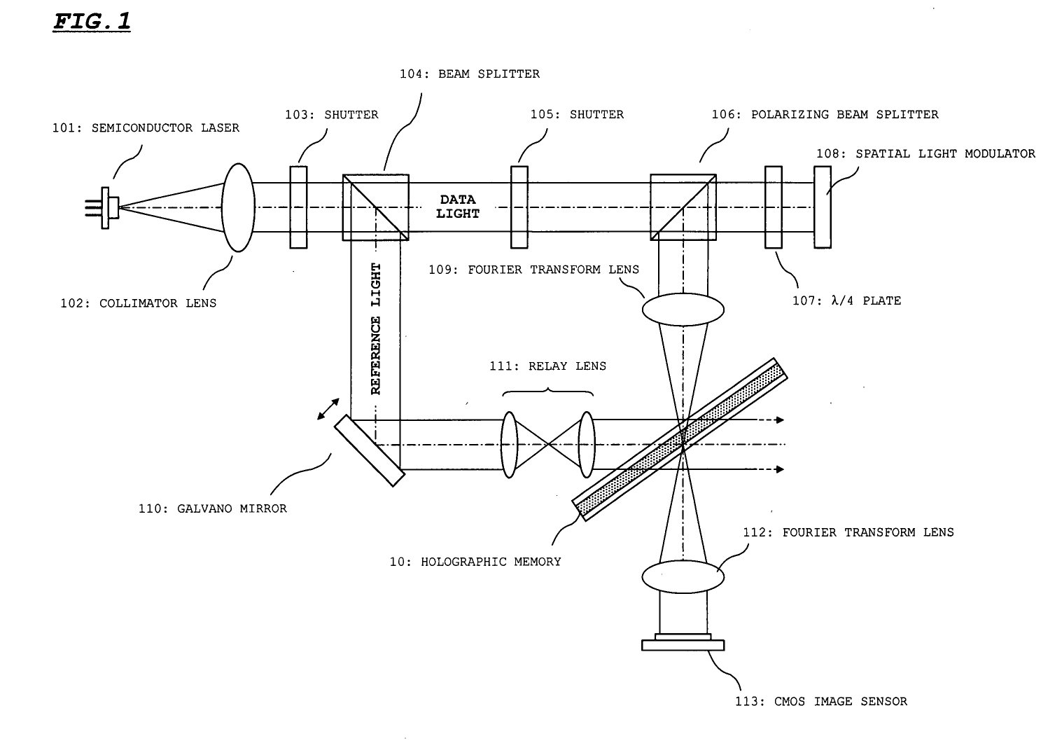

FIG. 1 shows an optical system of a holographic memory device according to Embodiment 1 of the present invention. The optical system shown in FIG. 1 is used when information is recorded/reproduced in a transmission type of holographic memory 10.

As shown in FIG. 1, this optical system includes a semiconductor laser 101, a collimator lens 102, a shutter 103, a beam splitter 104, a shutter 105, a polarizing beam splitter 106, a λ/4 plate 107, a spatial light modulator 108, a Fourier transform lens 109, a galvano mirror 110, a relay lens 111, and a Fourier transform lens 112, and a CMOS (Complementary MOS) image sensor 113.

The semiconductor laser 101 emits a laser light of a wavelength suited to the holographic memory 10. The collimator lens 102 converts the laser light made incident from the semiconductor laser 101 into a parallel light. The shutter 103 includes a mechanical shutter or the like, and passes/blocks a laser light according to a control signal. Specifically, an OFF (passing) state is set only at the time of exposure of a recording/reproducing operation. Based on time of the OFF state, exposure time for the holographic memory 10 is controlled. The beam splitter 104 splits the laser light from the collimator lens 102 into data light and reference light.

The shutter 105 includes a mechanical shutter or the like, and passes/blocks a data light according to a control signal. Specifically, an OFF (passing) state is set during recording, while an ON (blocking) state is set during reproduction.

The polarizing beam splitter 106 roughly fully passes a data light made incident from the shutter 105, and roughly fully reflects a data light made incident from the λ/4 plate 107. The λ/4 plate 107 converts the data light made incident from the polarizing beam splitter 106 from a linear polarized light into a circular polarized light, and a data light of a circular polarized light made incident from the spatial light modulator 108 into a linear polarized light orthogonal as compared with the incident time from the polarizing beam splitter 106.

The spatial light modulator 108 includes a combination of a liquid crystal panel and a reflection mirror, or the like, and controls a polarized state of a data light for each pixel according to a recording signal (binary data of 1 and 0), thereby subjecting the data light to spatial light modulation according to the recording signal.

A P-polarized data light which has passed through the polarizing beam splitter 106 is circularly polarized to turn left or right by the λ/4 plate 107. In this case, a turning direction of the data light is decided by a crystal axis direction of the λ/4 plate 107. For example, when the turning direction of the data light is right, the data light is reciprocated through the liquid crystal panel of the spatial light modulator 108 to keep its right turning in a pixel position of digital data “1”, and to change to left turning in a pixel position of digital data “0”. Accordingly, the data light passes again through the λ/4 plate 107 to be S-polarized in the pixel position of the digital data “1” and to be P-polarized in the pixel position of the digital data “0”. Of these, the S-polarized light alone with respect to the digital data “1” is reflected by the polarizing beam splitter 106, while the P-polarized light with respect to the digital data “0” passes through the polarizing beam splitter 106.

The Fourier transform lens 109 converges the data light made incident from the polarizing beam splitter 106 on the holographic memory material layer in the holographic memory 10.

The galvano mirror 110 reflects a reference light, and is rotated in an in-plane direction of a surface including optical axes of the data light and reference light according to a control signal. An incident angle of the reference light with respect to a recording block is adjusted by rotating the galvano mirror 110. The relay lens 111 guides the reference light reflected by the galvano mirror 110 to the recording block of the holographic memory 10.

The Fourier transform lens 112 transforms the reference light diffracted by the holographic memory material layer and passed through the holographic memory 10 (reference light after passage through the holographic memory 10 will be particularly referred to as “reproduction light”, hereinafter) into a parallel light, and guides it to the CMOS image sensor 113. The CMOS sensor 113 outputs an electric signal to a signal amplification circuit (described below) according to an intensity distribution of the reproduction light received through the Fourier transform lens 112.

During recording, the laser light emitted from the semiconductor laser 101 is transformed into a parallel light by the collimator lens 102, then passes through the shutter 103, and is split into data light and reference light by the beam splitter 104. Of these, the data light passes through the shutter 105, then is transmitted through the polarizing beam splitter 106, and modulated by the spatial light modulator 108. The data light modulated by the spatial light modulator 108 is reflected by the polarizing beam splitter 106, and converged and applied to the holographic memory 10 by the Fourier transform lens 109. The reference light is reflected by the galvano mirror 110, and then made incident through the relay lens 111 on a data light applied position of the holographic memory 10.

This way, the data light and reference light are applied on the holographic memory material layer of the holographic memory 10. Accordingly, an interference fringe is generated in a laser light applied place of the holographic memory material layer, and a monomer is polymerized according to this interference fringe. As a result, are fractive index distribution is fixed on the hologram material layer according to the interference fringe to execute recording in the holographic memory 10.

During recording by angular multiplexing, the galvano mirror 110 is rotated by a predetermined angle (the amount of page feeding) to change the incident angle of the reference light on the holographic memory 10. At this time, the reference light reflected by the galvano mirror 10 passes through the relay lens 111 so that it is applied to an applied position of the data light by changing an angle alone with respect to the holographic memory 10 without changing the incident position on the holographic memory 10. A recording signal of a next page is supplied to the spatial light modulator 108 according to the angle changing of the reference light. The angle changing of the reference light and the changing of the recording signal with respect to the spatial light modulator 108 are repeated until the end of multiple recording in the recording block. Thus, interference fringes different from incident angle to angle of the reference light are generated in the recording block, whereby a refractive index distribution is fixed in the recording block according to the different interference fringes. As a result, different recording signals are recorded in the recording block by angular multiplexing.

During reproduction, the laser light emitted from the semiconductor laser 101 is converted into a parallel light by the collimator lens 102, passes through the shutter 103, and is split into data light and reference light by the beam splitter 104. Of these, the data light is blocked by the shutter 105. On the other hand, the reference light is applied to the holographic memory material layer of the holographic memory 10 through the galvano mirror 110 and the relay lens 111.

Subsequently, the reference light is diffracted by the interference fringe fixed on the holographic memory material layer to pass through the holographic memory 10. Then, the reference light (reproduction light) is transformed into a parallel light by the Fourier transform lens 112 to be made incident on the CMOS image sensor 113.

The CMOS image sensor 113 outputs an electric signal to the signal amplification circuit (described below) according to an intensity distribution of the received reproduction light. Here, the intensity distribution of the reproduction light received by the CMOS image sensor 113 is compliant with the spatial light modulation applied to the data light by the spatial light modulator 108 during the recording. The CMOS image sensor 113 is adjusted for a position of a direction parallel to a photodetecting surface and an angle of inplane-direction of the photodetecting surface by an adjusting mechanism (not shown).

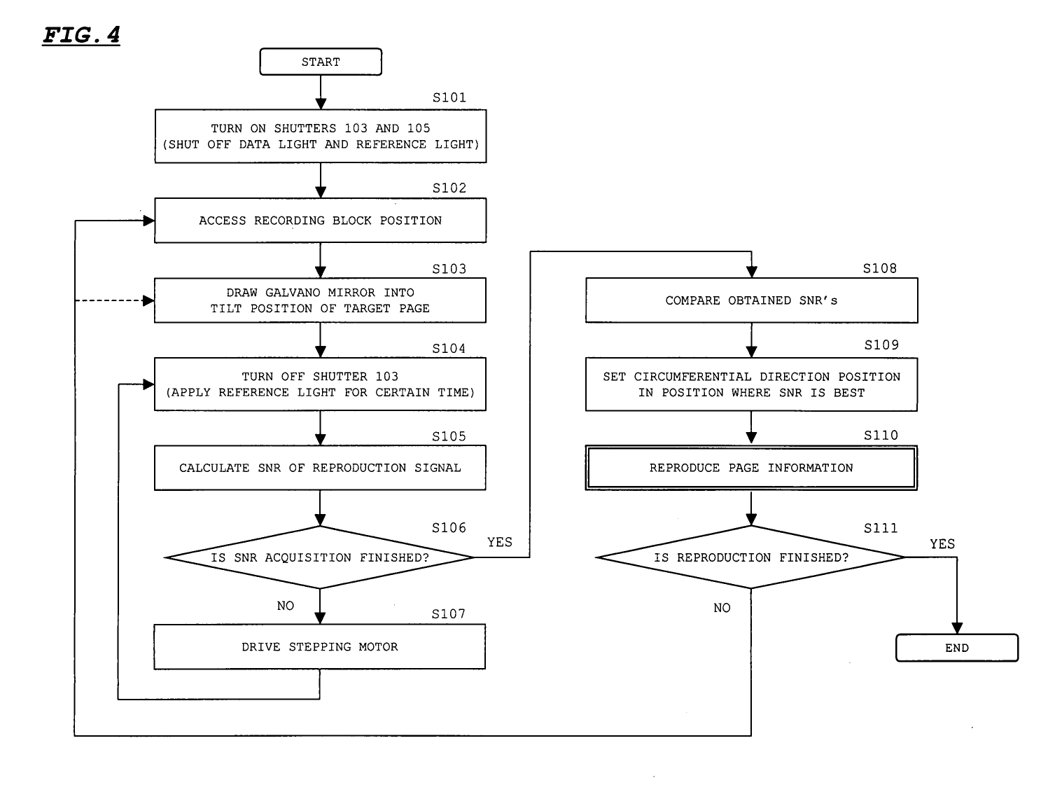

The electric signal output from the CMOS image sensor 113 is amplified by the signal amplification circuit, and then demodulated by a decoder. At this time, processing for compensating for a tilt error of the reference light with respect to the holographic memory 10 is executed. This processing will be described in detail below by referring to FIG. 4.

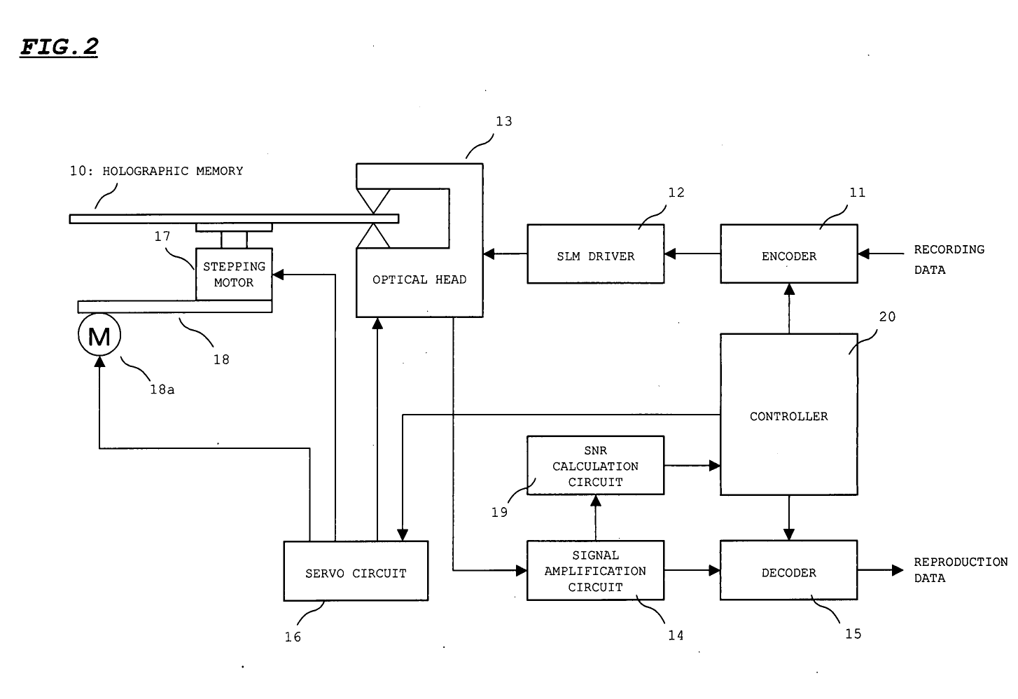

FIG. 2 is a diagram showing a configuration of the holographic memory device according to this embodiment. As shown, the holographic memory device includes an encoder 11, an SLM driver 12, an optical head 13, a signal amplification circuit 14, a decoder 15, a servo circuit 16, a stepping motor 17, a feed mechanism 18, an SNR calculation circuit 19, and a controller 20.

The encoder 11 encodes recording data to send it to the SLM driver 12. The SLM driver 12 generates a recording signal from the encoded recording data to drive the spatial light modulator 108, and drives the spatial light modulator 108 in the optical head 13 according to the generated recording signal.

The optical head 13 incorporates the optical system of FIG. 1, and applies data light and reference light for recording and reproducing to the holographic memory (disk medium) 10. The optical head 13 is arranged so that applied positions of the data light and reference light can move on one diameter of the holographic memory 10 when the holographic memory 10 is fed stepwise in the direction of the diameter (referred to as “radial direction”, hereinafter) as described below. The optical head 13 is arranged so that the data light and reference light can be made incident from a direction vertical to this diameter (referred to as “tangential direction”, hereinafter).

The signal amplification circuit 14 amplifies an electric signal output from the CMOS image sensor 113 in the optical head 13, and sends it to the decoder 15 and the SNR calculation circuit 19. The decoder 15 decodes a reproduction signal input from the signal amplification circuit 14 to generate reproduction data, and sends this to a circuit of a subsequent stage.

The servo circuit 16 generates a servo signal to feed the holographic memory 10 stepwise in a disk circumferential direction according to a control command from the controller 20, and sends this to the stepping motor 17. The servo circuit 16 also generates a servo signal to feed the holographic memory 10 stepwise in a radial direction according to a control command from the controller 20, and sends this to a driving motor 18a of the feed mechanism 18. Further, the servo circuit 16 drives and controls the semiconductor laser 101 arranged in the optical head 13, controls turning ON/OFF of the shutters 103 and 105, and drives and controls the galvano mirror 110 according to control commands from the controller 20.

The stepping motor 17 feeds the holographic memory 10 stepwise in the disk circumferential direction according to a servo signal from the servo circuit 16. The feed driving mechanism 18 slidably supports the stepping motor 17 to enable mutual movements of the optical head 13 and the holographic memory 10 in the radial direction. The motor (steppingmotor) 18 a provides a driving force to feed the stepping motor 17 stepwise in the radial direction.

The SNR calculation circuit 19 calculates an SNR (Signal to Noise Ratio) of the reproduction signal according to a calculation equation described below, and outputs a result of the calculation to the controller 20. The controller 20 outputs a control command to each circuit during a recording/reproducing operation.

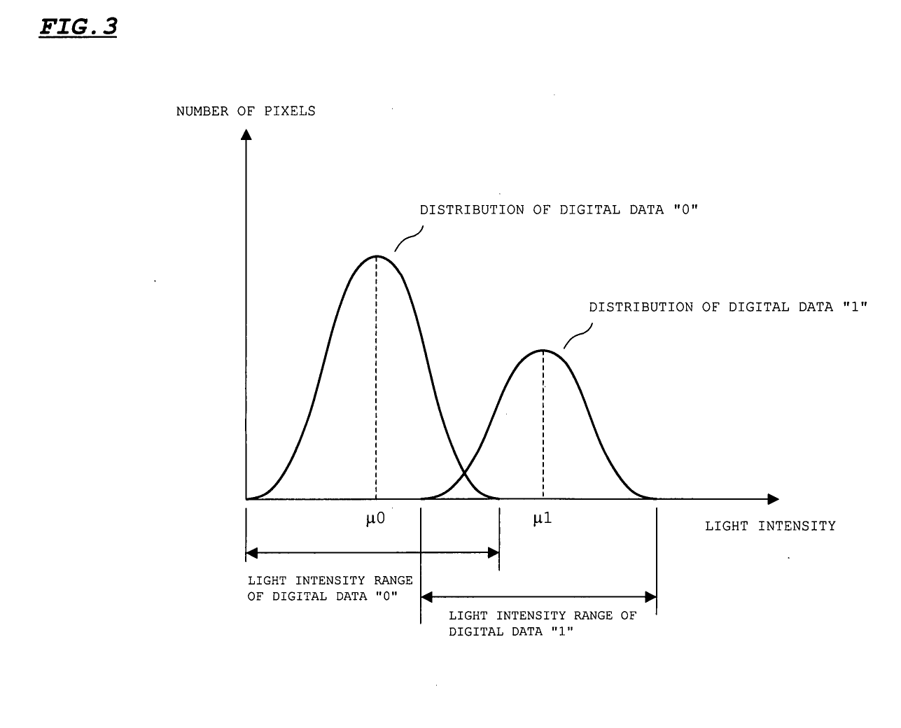

Next, an SNR calculation method in the SNR calculation circuit 19 will be described by referring to FIG. 3.

As described above, the spatial light modulator 108 controls a light polarized state for each pixel according to a recording signal, thereby subjecting the data light to spatial light modulation according to the recording signal. In this case, for example, presuming that the spatial light modulator 108 is driven to change not a phase of the data light in a pixel position of digital data “1” but the phase of the data light by 180° in a pixel position of digital data “0”, when the reference light is applied at a proper angle to the holographic memory 10 in which the recording has been executed, ideally, on the photodetecting surface of the CMOS image sensor 113, light intensity equal to intensity P1 is generated in the pixel position of the digital data “1”, and light intensity equal to intensity P2 is generated in the pixel position of the digital data “0”.

In reality, however, the intensity in the pixel position of the digital data “1” is not uniformly equal to the intensity P1 because of light leakage or the like, resulting in light intensity within arranges lightly shifted from the intensity P1. Similarly, the intensity in the pixel position of the digital data “0” is not uniformly equal to the intensity P2, resulting in light intensity within a range slightly shifted from the intensity P2.

Thus, when the reference light is applied at the proper angle to the holographic memory 10, generally, the number of pixels each having light intensity is distributed as shown in FIG. 3.

In this case, as an over lapped portion between a distribution curve of the digital data “0” and a distribution curve of the digital data “1” is smaller, a range unclear as to which of the digital data “0” and “1” is used for demodulation is narrower, thereby reducing an error rate in the reproduction signal. In other words, as this overlapped portion is smaller, the quality of the reproduction signal is better.

Accordingly, the quality of the reproduction signal is better as μ1−μ0 is larger and as σ1+σ0 is smaller, where μ0 is an average value of light intensity in the distribution curve of the digital data “0”, σ0 is a standard deviation of the distribution curve, μ1 is an average value of light intensity in the distribution curve of the digital data “1”, and σ1 is a standard deviation of the distribution curve.

From this, for example, an SNR of the reproduction signal can be obtained by the following equation.
SNR=20·log {(μ1−μ0)/(σ1+σ0 )} (1)

For example, the SNR calculation circuit 19 calculates an SNR of the reproduction signal input from the signal amplification circuit 14 according to the equation (1), and outputs a result of the calculation to the controller 20.

The SNR calculation equation is not limited to the equation (1). Other equations can be used as long as the quality of the reproduction signal can be evaluated. For example, the SNR of the reproduction signal can be obtained only from a size of μ1−μ0 or a size of σ1+μ0. In the case of obtaining the SNR from the size of μ1−μ0, the quality of the reproduction signal is better as this value is larger. In the case of obtaining the SNR from the size of σ1+σ0, the quality of the reproduction signal is better as this value is smaller.

Next, a recording operation of the holographic memory device will be described.

Upon a start of the recording operation, the shutter 103 is turned ON (blocking) while the shutter 105 is turned OFF (passing), and the optical head 13 accesses a recording block position. This accessing is executed by stepwise feeding (disk circumferential direction) of the holographic memory 10 by the stepping motor 17 and stepwise feeding (radial direction) of the holographic memory 10 by the feed mechanism 18.

Next, the galvano mirror 110 is set to an initial angle corresponding to a first page, and the shutter 103 is turned OFF (passing) for exposure time to record the page. At this time, the spatial light modulator 108 is driven to be provided with a pixel pattern corresponding to recording data of the page.

Upon recording of recording data of a head page in the recording block by the exposure, the controller 20 determines the presence of more data to be recorded. If there is data to be recorded, the galvano mirror 110 is rotated by an angle equivalent to the amount of page feeding, and recording data of a next page is recorded in the recording block as in the fore going case. The data recording by angular multiplexing is repeatedly executed until the end of the data recording in the recording block.

Upon the end of the recording in the recording block, when there is more data to be recorded, a next recording block is accessed, and recording is executed in the next recording block by angular multiplexing as in the foregoing case.

Next, a reproducing operation of the holographic memory device will be described by referring to FIG. 4.

Upon a start of the reproducing operation, the shutters 103 and 105 are both turned ON (blocking states) (S101), and then the optical head 13 access a reproducing-target recording block position (S102) . As in the case of the recording, this accessing is executed by stepwise feeding (disk circumferential direction) of the holographic memory 10 by the stepping motor 17 and stepwise feeding (radial direction) of the holographic memory 10 by the feed mechanism 18.

Accordingly, upon the accessing of the optical head 13, next, drawing control of the galvano mirror 110 is executed for the reproduction target page (S103). For example, this drawing control is carried out as follows.

First, the shutter 103 is turned OFF (passing) to apply a reference light to the recording block. Subsequently, the galvano mirror 110 is rotated from an initial position in an angle direction corresponding to the head page (firstpage). During this rotation, an output of the CMOS image sensor 113 is monitored as occasion demands. Then, an angle position of the galvano mirror 110 in which this output first becomes a peak is detected as an angle position corresponding to the head page (first page).

After the detection, the galvano mirror 110 is rotated more by the amount of page feeding to the reproduction target. Further, the galvano mirror 110 is fine-adjusted to a position in which the output of the CMOS image sensor 113 becomes maximum. Accordingly, a tilt error between the reproduction target page and the reference light in the in-plane direction of the surface of including the data light and reference light is corrected, whereby the galvano mirror 110 is drawn to the angle position of the reproduction target page. Upon the end of the drawing, the shutter 103 is turned ON (blocking).

Thus, upon the end of the drawing of the galvano mirror 110, the shutter 113 is turned OFF for reproduction exposure time (S104). Based on a reproduction signal obtained at this time, the SNR is calculated by the SNR calculation circuit 19 (S105). Subsequently, determination is made as to acquisition of SNR in all step positions within a fixed back and forth range of the disk circumferential direction from the position (initial access position) where the access is made in S102 (S106). In this case, if all SNR's have not been obtained (S106: NO), the stepping motor 17 is driven by only one step to set the optical head 13 in a next step position of the disk circumferential direction (S107). Then, as in the foregoing case, the shutter 113 is turned OFF for reproduction exposure time (S104). Based on a reproduction signal obtained at this time, an SNR is calculated (S105).

The SNR calculation processing is repeated until acquisition of SNR in all the step positions within the fixed back and forth range of the disk circumferential direction from the initial access position (S106). Then, upon the acquisition of all SNR's within the range (S106: YES), next, the obtained SNR's are compared with one another (S108), and the stepping motor 17 is driven to set the optical head 13 in a disk circumferential direction position of best SNR among them (S109). Accordingly, after the setting of the circumferential direction, the shutter 113 is turned OFF for reproduction exposure time to execute reproduction processing for the reproduction target page (S110).

In place of the processing of S109 and S110, each reproduction signal read in the acquisition processing of SNR (S104 to S107) may be demodulated by the decoder 15 to be stored in a memory (not shown) beforehand, and data corresponding to the reproduction signal of best SNR may be selected from the reproduction signals to be output as reproduction data of the reproduction target page.

Accordingly, upon the reproduction of the reproduction target page, determination is made as to whether all reproduction target pages have been reproduced (S111). In this case, when there is a page to be reproduced (S111: NO), the process returns to S102 or S103 to execute reproduction processing for a next reproduction target page. In other words, when there is a page to be reproduced in the recording block, the process returns to S103 to execute drawing processing for this page, and then processing of S104 and after is executed. When there are more pages to be reproduced in another recording block, the process returns to S102 to access this recording block. Subsequently, drawing processing is executed for the reproduction target page in S103, and then processing of S104 and after is executed.

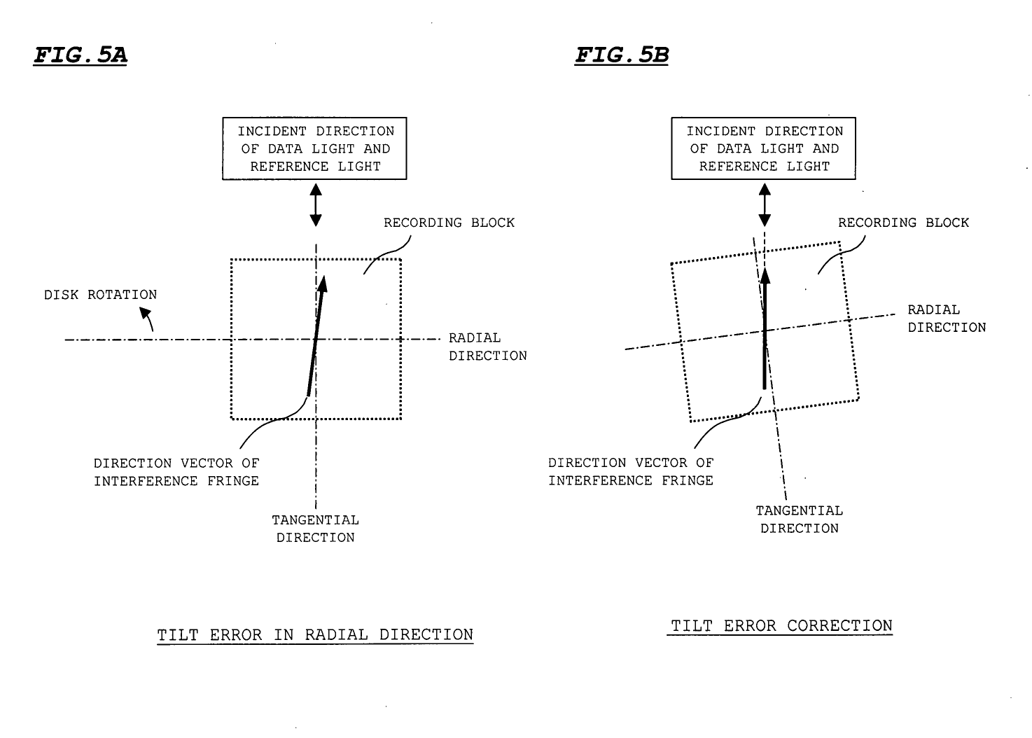

According to this embodiment, as the processing of S104 to S109 suppresses a tilt error of a radial direction generated between the reproduction target page and the reference light, the high-quality reproduction data can be demodulated. In other words, even when a tilt error of a radial direction occurs in the direction vector of the interference fringe as schematically shown in FIG. 5A, as shown in FIG. 5B, the holographic memory 10 is rotated to the position of best SNR so that the tilt error of the vector direction of the interference fringe in the radial direction can be suppressed. As described above, the tilt error of the direction vector of the interference fringe in a direction vertical to the paper surface of the drawing is corrected by fine-adjusting the galvano mirror 110.

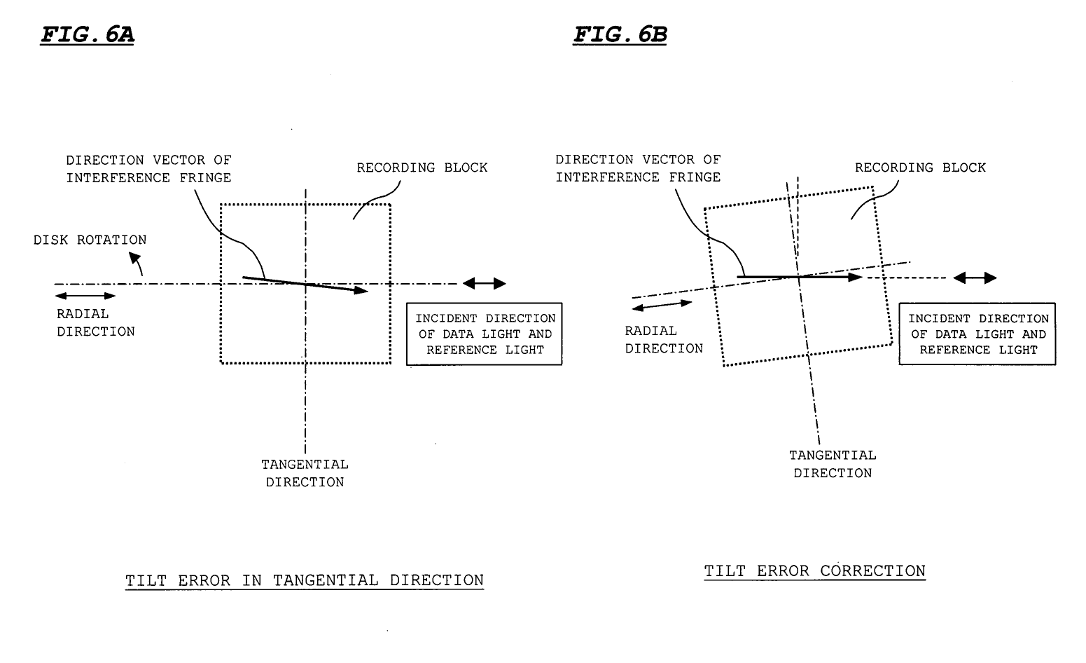

According to this embodiment, the optical head 13 is arranged so that the incident direction of the data light and reference light is a tangential direction. However, even when the optical head 13 is arranged so that the incident direction of the data light and reference light is a radial direction, a tilt error which cannot be adjusted by the galvano mirror 110 can be suppressed through the processing shown in FIG. 4. In other words, even when a tilt error of a tangential direction occurs in the direction vector of the interference fringe as schematically shown in FIG. 6A, as shown in FIG. 6B, the holographic memory 10 is rotated to the position of best SNR so that the tilt error of the direction vector of the interference fringe in the tangential direction can be suppressed.

Similarly, when the optical head 13 is arranged so that the incident directions of the data light and reference light are between radial and tangential directions, a tilt error which cannot be adjusted by the galvano mirror 110 can be suppressed through the processing shown in FIG. 4.

### Embodiment 2

According to Embodiment 1 of the present invention, the SNR of the reproduction signal is actually calculated, and the disk circumferential direction position of the holographic memory 10 is set in the position of the best SNR of the reproduction signal. According to this embodiment, however, a tilt amount of a holographic memory 10 is detected by a tilt detector, and a disk circumferential direction position of the holographic memory 10 is set in a position where a tilt error may be suppressed, based on the detected tilt amount. According to this embodiment, as in the case of Embodiment 1 of the present invention, it is presumed that data light and reference light are made incident on the holographic memory 10 in a tangential direction.

According to this embodiment, a table in which a tilt amount of a radial direction of the holographic memory 10 is associated with a correction amount of the disk circumferential direction there of is held in a memory incorporated in a controller 20. In the table, how much the holographic memory 10 is rotated in the disk circumferential direction to obtain best quality of a reproduction signal when tilt occurs in the radial direction of the holographic memory 10 is calculated beforehand, and a tilt amount and the rotational amount of the disk circumferential direction are associated with each other based on a result there of. According to this embodiment, the number of steps for a stepping motor 17 is held as a correction amount of the disk circumferential direction in the table.

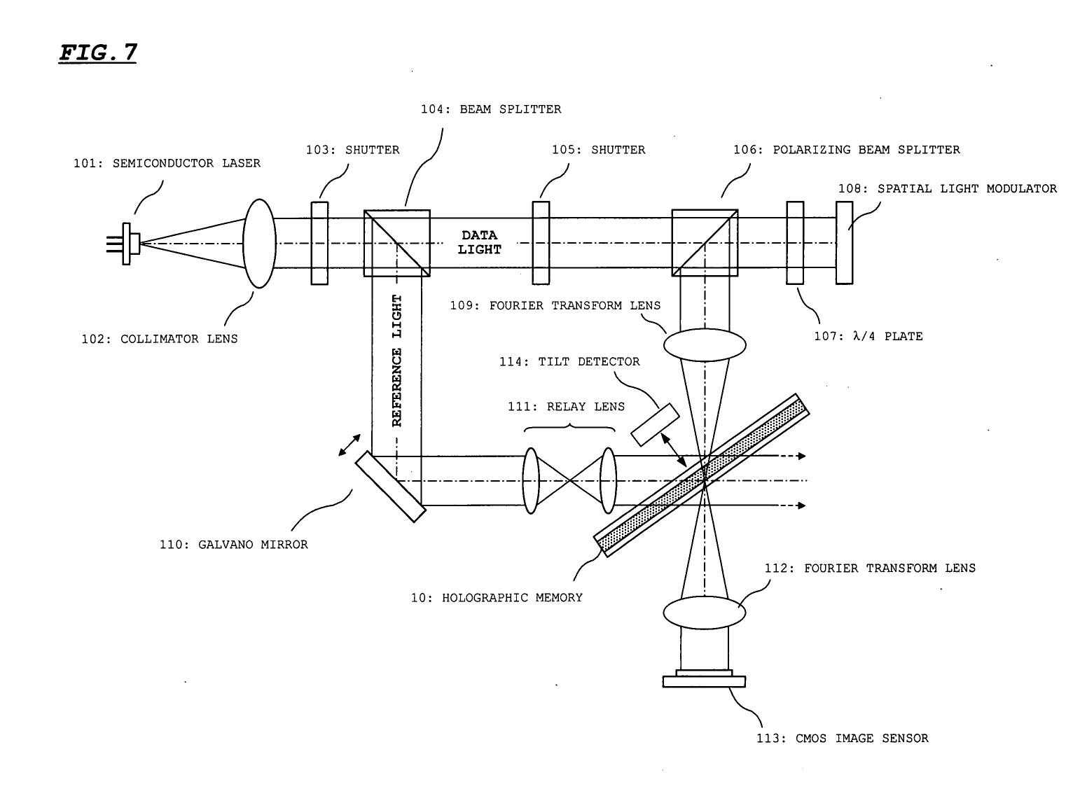

FIG. 7 shows an optical system of an optical head 13 according to this embodiment. As shown, in the optical system of this embodiment, a tilt detector 114 is arranged to detect the tilt amount of the radial direction of the holographic memory 10. Other components are similar to those of Embodiment 1 of the present invention. A conventionally known detector can be used for the tilt detector 114. For example, it is possible to employ a configuration in which a laser light is applied to the holographic memory 10 and its reflected light is detected by a 2-division sensor. In this case, an output of the 2-division sensor is subjected to subtraction to detect a direction and an amount of tilt.

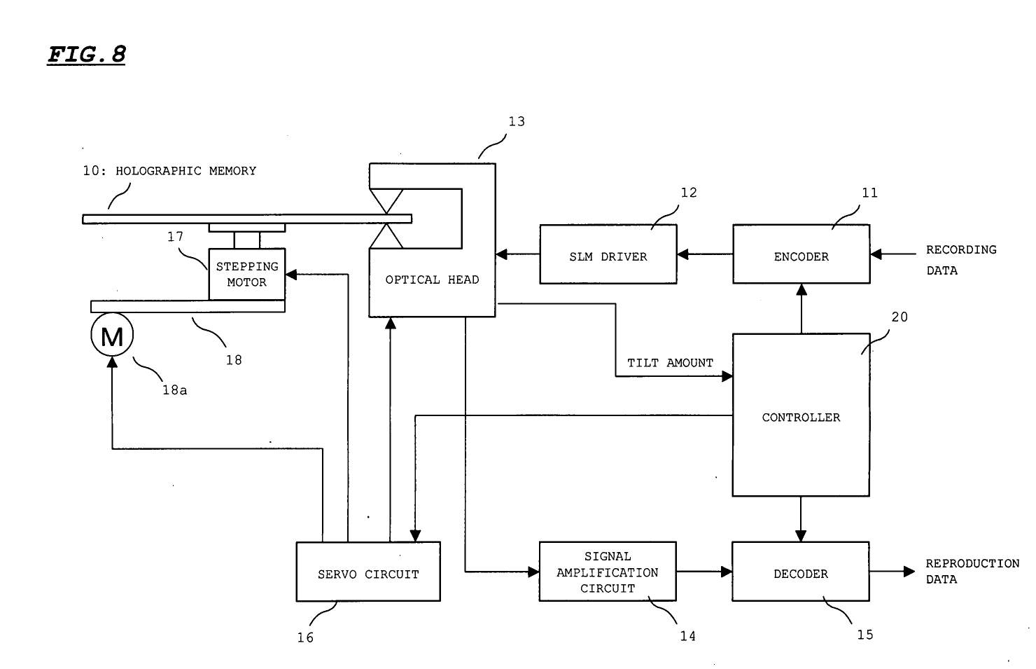

FIG. 8 shows a configuration of the holographic memory device according to this embodiment. As shown, according to the embodiment, as compared with the configuration of FIG. 2, the SNR calculation circuit 19 is omitted. In the memory incorporated in the controller 20, as described above, the table in which the tilt amount of the radial direction of the holographic memory 10 is associated with the correction amount of the disk circumferential direction there of is held. This table is structured by associating a range of a tilt amount and the number of steps for the stepping motor 17 with each other, for example, as follows:
Tilt amount: +Ti0 to +Ti1, number of steps: +ST0,
Tilt amount: +Ti1 to +Ti2, number of steps: +ST1,
The table is uniformly applied irrespective of a diameter direc position of the holographic memory 10.

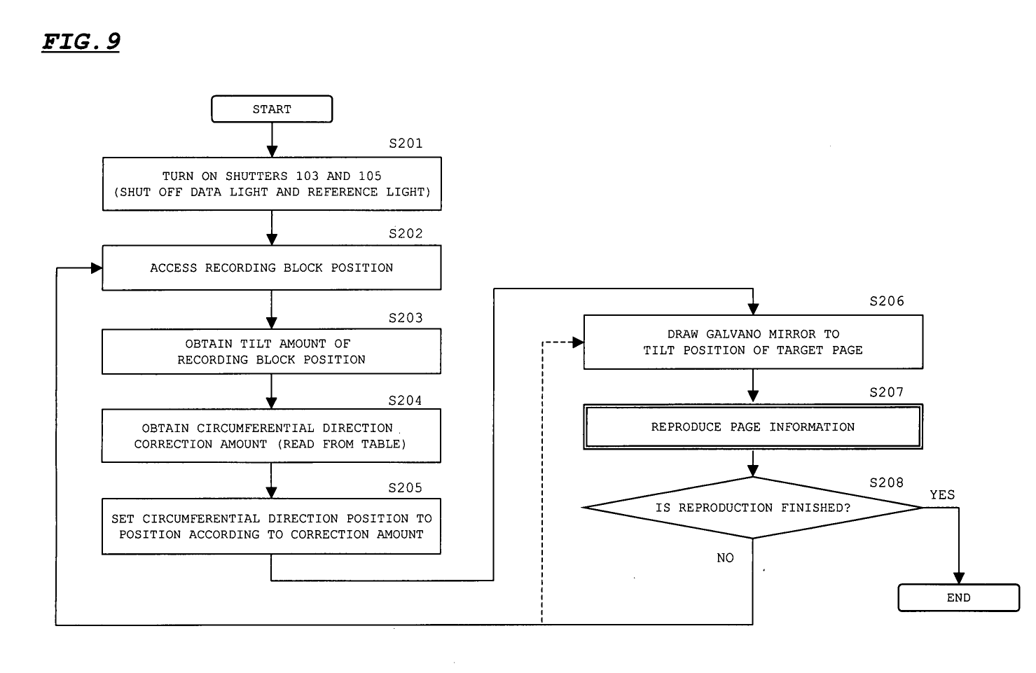

A reproducing operation will be described by referring to FIG. 9. Upon a start of the reproducing operation, the shutters 103 and 105 are both turned ON (blocking states) (S201), and then the optical head 13 access a reproducing-target recording block position (S202). As in the case of Embodiment 1 of the present invention, this accessing is executed by stepwise feeding (disk circumferential direction) of the holographic memory 10 by the stepping motor 17 and stepwise feeding (radial direction) of the holographic memory 10 by a feed mechanism 18.

Thus, upon the accessing of the optical head 13, next, a tilt amount in the recording block position is detected by the tilt detector 114 (S203) . Then, a correction amount (number of steps) corresponding to the detected tilt amount is read from the memory in the controller 20 (S204), and the stepping motor 17 is driven by the number of steps corresponding to the correction amount (S205). Accordingly, a tilt error in the radial direction is corrected.

Subsequently, as in the case of Embodiment 1 of the present invention, drawing control of a galvano mirror 110 with respect to a reproduction target page is executed (S206). During the drawing control, as in the case of Embodiment 1 of the present invention, a tilt error between the reproduction target page in an in-plane direction of a surface including data light and reference light, and the reference light is corrected. Upon the end of the drawing of the galvano mirror 110, the shutter 103 is turned ON (blocking).

Subsequently, the shutter 103 is turned OFF for reproduction exposure time to execute reproduction processing for the reproduction target page (S207).

Subsequently, upon reproduction of the reproduction target page, determination is made as to whether all reproduction target pages have been reproduced (S208). Here, when there is a page to be reproduced (S208: NO), the process returns to S202 or S206 to execute reproduction processing for a next reproduction target page. In other words, when there is still a page to be reproduced in the recording block, the process returns to S206 to execute drawing processing for this page, and then reproduction processing of S207 is executed. When there are more pages to be reproduced in another recording block, the process returns to S202 to access the recording block, and tilt of the radial direction is corrected in S203 to S205. Subsequently, drawing processing is executed for the reproduction target page in S206, and reproduction processing is executed in S207.

According to this embodiment, as in the case of Embodiment 1 of the present invention, as the tilt error of the radiation direction generated between the reproduction target page and the reference light is suppressed, it is possible to demodulate high-quality reproduction data. In this case, the correction amount of the disk circumferential direction is obtained from the table held in the controller 20. Hence, processing can be simplified as compared with the case of actually calculating the SNR in Embodiment 1 of the present invention.

According to this embodiment, the optical head 13 is arranged so that the incident direction of the data light and reference light is a tangential direction. However, even when the optical head 13 is arranged so that the incident direction of the data light and reference light is a radial direction, the tilt error of the tangential direction can be suppressed by the same processing as that of the foregoing. In this case, however, the tilt detector 114 is configured to detect tilt of the holographic memory 10 in the tangential direction. A tilt amount of the tangential direction and a correction amount of the disk circumferential direction are defined in the table held in the controller 20.

The embodiments of the present invention have been described. Needless to say, however, those embodiments are in no way limitative of the invention, and various changes can be made.

For example, a light source for emitting the data light and reference light is not limited to the semiconductor laser 101. It may be, e.g., an SHG laser.

The shutters 103 and 105 are not limited to the mechanical shutters, but they may be liquid crystal shutters.

The spatial light modulator 108 is not limited to the combination of the liquid crystal and the mirror, but it may be a DMD (Digital Micro-mirror Device) . For the spatial light modulator 108, a light transmission type of spatial light modulator made of a liquid crystal alone can be used. In this case, the spatial light modulator is arranged in a latter part of the shutter 105 in the optical system of FIG. 1.

The incident position of the reference light can be adjusted by combining two or more mirrors in place of the relay lens 111.

The photodetector for detecting an interference light is not limited to the CMOS image sensor 113. For example, it may be a CCD image sensor.

The multiplexing method is not limited to the angular multiplexing. Another multiplexing method or a combination of various multiplexing methods may be employed.

The radial stepwise-feeding of the holographic memory 10 is not limited to the configuration of feeding the stepping motor 17 stepwise. It is possible to use a configuration of feeding the optical head 13 in the radial direction of the holographic memory 10.

Each of the embodiments is directed to the hologram memory device which uses the transmission type of hologram memory. However, the present invention can be applied to a reflective type of hologram memory device.

When processing for fixing the interference fringe is necessary, fixing processing is executed after the recording operation as occasion demands. For this fixing processing, a method of using a reference light as a light for fixing, and various other methods such as a method of separately arranging a dedicated laser light can be used.

Various changes can be made of the embodiments of the present invention within a scope of technical ideas described in appended claims as occasion demands.

1. A holographic memory device for reproducing binary data of 1 and 0, which are recorded in a holographic memory medium by being optically modulated for each pixel, by applying a reference light to the holographic memory medium, characterized by comprising:
photodetecting means for detecting the reference light diffracted by the holographic memory medium and outputting a signal for each pixel based on a diffracted state;
quality detecting means for detecting quality of the signal output from the photodetecting means;
position changing means for changing a rotational position of the holographic memory medium;
position detecting means for detecting the rotational position of the holographic memory medium when the quality is proper based on a detecting result by the quality detecting means; and
reproduction data obtaining means for obtaining reproduction data from the signal output from the photodetecting means when the holographic memory medium is in the rotational position detected by the position detecting means.

2. A holographic memory device according to claim 1, wherein:
the quality detecting means detects the quality of the signal output from the photodetecting means each time the rotational position of the holographic memory medium is changed; and
the position detecting means detects a rotational position, at which the quality detected by the quality detecting means is best, as the rotational position of the holographic memory during the reproduction.

3. A holographic memory device according to claim 1, wherein the quality detecting means detects the quality of the signal output from the photodetecting means based on a difference between an average value μ1 of signal values of a signal group corresponding to the binary data of 1 and an average value μ0 of signal values of a signal group corresponding to the binary data of 0 among the signals output from the photodetecting means for the respective pixels.

4. A holographic memory device according to claim 1, wherein the quality detecting means detects the quality of the signal output from the photodetecting means based on a sum of a standard deviation σ1 of signal values of a signal group corresponding to the binary data of 1 and a standard deviation σ0 of signal values of a signal group corresponding to the binary data of 0 among the signals output from the photodetecting means for the respective pixels.

5. A holographic memory device according to claim 1, wherein the quality detecting means detects the quality of the signal output from the photodetecting means based on a difference between an average value μ1 of signal values of a signal group corresponding to the binary data of 1 and an average value μ0 of signal values of a signal group corresponding to the binary data of 0, and a sum of a standard deviation σ0 of signal values of the signal group corresponding to the binary data of 1 and a standard deviation σ0 of signal values of the signal group corresponding to the binary data of 0, among the signals output from the photodetecting means for the respective pixels.

6. A holographic memory device for reproducing data recorded in a holographic memory medium by applying a reference light to the holographic memory medium, characterized by comprising:
tilt detecting means for detecting a tilt of the holographic memory medium; and
adjusting means for adjusting, based on a detecting result by the tilt detecting means, a rotational position of the holographic memory medium to a position at which an influence of the tilt is suppressed.

7. A holographic memory device according to claim 6, wherein the adjusting means is provided with a table in which an amount of the tilt and a correction amount of the rotational position are associated with each other.

8. A holographic memory device for reproducing data recorded in a holographic memory medium by applying a reference light to the holographic memory medium, characterized by comprising:
photodetecting element for detecting the reference light diffracted by the holographic memory medium and outputting a signal for each pixel based on a diffracted state; and
control circuit for performing processing including:
quality detecting processing for detecting quality of the signal output from the photodetecting element;
position changing processing for changing a rotational position of the holographic memory medium;
position detecting processing for detecting the rotational position of the holographic memory medium when the quality is proper based on a detecting result in the quality detecting processing; and
reproduction data obtaining processing for obtaining reproduction data from the signal output from the photodetecting means when the holographic memory medium is in the rotational position detected in the position detecting processing.

9. A holographic memory device according to claim 8, wherein:
the quality detecting processing detects the quality of the signal output from the photodetecting element each time the rotational position of the holographic memory medium is changed; and
the position detecting processing detects a rotational position, at which the quality detected in the quality detecting processing is best, as the rotational position of the holographic memory during the reproduction.

10. A holographic memory device according to claim 2, wherein the quality detecting means detects the quality of the signal output from the photodetecting means based on a difference between an average value σ1 of signal values of a signal group corresponding to the binary data of 1 and an average value μof signal values of a signal group corresponding to the binary data of 0 among the signals output from the photodetecting means for the respective pixels.

11. A holographic memory device according to claim 2, wherein the quality detecting means detects the quality of the signal output from the photodetecting means based on a sum of a standard deviation σ1 of signal values of a signal group corresponding to the binary data of 1 and a standard deviation σ0 of signal values of a signal group corresponding to the binary data of 0 among the signals output from the photodetecting means for the respective pixels.

12. A holographic memory device according to claim 2, wherein the quality detecting means detects the quality of the signal output from the photodetecting means based on a difference between an average value μ1 of signal values of a signal group corresponding to the binary data of 1 and an average value μ0 of signal values of a signal group corresponding to the binary data of 0, and a sum of a standard deviation σ0 of signal values of the signal group corresponding to the binary data of 1 and a standard deviation σ0 of signal values of the signal group corresponding to the binary data of 0, among the signals output from the photodetecting means for the respective pixels.
